(19) United States
(12) Patent Application Publication
(10) Pub. No.: US 2013/0318624 A1
(43) Pub. Date: Nov. 28, 2013

(54) METHOD AND DEVICE FOR CONTROLLING DISTRIBUTION OF LICENSES

(71) Applicants: Antoine Monsifrot, Rennes (FR); Gwenael Doerr, Rennes (FR); Olivier Courtay, Rennes (FR); Antoine Robert, Mezieres Sur Couesnon (FR); Marc Joye, Fougeres (FR)

(72) Inventors: Antoine Monsifrot, Rennes (FR); Gwenael Doerr, Rennes (FR); Olivier Courtay, Rennes (FR); Antoine Robert, Mezieres Sur Couesnon (FR); Marc Joye, Fougeres (FR)

(21) Appl. No.: 13/984,068

(22) PCT Filed: Feb. 6, 2012
(86) PCT No.: PCT/EP2012/051976

§ 371 Date: Aug. 7, 2013

(30) Foreign Application Priority Data
Feb. 10, 2011 (EP) 11305132.0

(51) Int. Cl. G06F 21/10

(52) U.S. Cl. CPC G06F 21/105
USPC 726/26

(57) ABSTRACT

A method for controlling distribution of licenses, a license being for an excerpt of a content item, the content item comprising a set of continuous units, each excerpt comprising a subset of the set of continuous units, A device receives an identifier of a receiver of a license, and the license or a request to generate the license, the license or the request to generate the license comprising a content identifier and at least one indicator of the units covered by the license; retrieves stored information regarding licenses previously delivered to the receiver; compares a limit value for the content item with the stored information combined with information from the license or the request to generate the license; and allows the receiver access to the license only if the limit value is not exceeded by the stored information combined with information from the license or the request to generate the license Also provided is the device.

### TECHNICAL FIELD

The present invention relates generally to Digital Rights Management (DRM), and more particularly to a DRM solution that controls user distribution of excerpts of a content item.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

DRM solution are often considered as user unfriendly, a common complaint being that DRMs prohibit fair use as defined by the Digital Millennium Copyright Act, 1998 [see http://www.copyright.gov/legislation/dmca.pdf]. Among the many things considered as part of fair use is the right of an end user to cite or use an excerpt of a work, i.e. content item, for criticism, scholarship and so on. This is however not possible with the prior art DRM solutions.

It will therefore be appreciated that there is a need for a DRM solution that can:
Protect a content item against illegal or unauthorized use.
Allow an end user to extract a portion of the content item and redistribute the portion to other end users who may then access the portion, regardless of whether or not these end users have access rights to the entire content item.
Make it difficult for colluding end users to distribute an entire work freely by concatenating a set of excerpts of the work.

The present invention provides a part of such a solution: to wit, it provides the anti-collusion part.

### SUMMARY OF INVENTION

The present application comprises a plurality of claims in each category. The skilled person will appreciate that the claims belong to a common inventive concept and that they cannot be expressed in an umbrella claim.

In a first aspect, the invention is directed to an apparatus for controlling distribution of licenses, a license being for an excerpt of a content item, the content item comprising a set of units, each excerpt comprising a subset of the set of units, the apparatus comprising a processor configured to: receive a license for the excerpt of the content item, the license comprising at least one indicator of the units covered by the license; retrieve stored information regarding licenses previously delivered to the apparatus; compare a limit value for the content item with the stored information combined with information from the license; and use the license to access the excerpt only if the limit value is not exceeded by the stored information combined with information from the license.

In a first preferred embodiment, the processor is further configured to receive the excerpt of the content item.

In a second aspect, the invention is directed to an apparatus for controlling distribution of licenses, a license being for an excerpt of a content item, the content item comprising a set of units, each excerpt comprising a subset of the set of units, the apparatus comprising a processor configured to: receive, from a device, an encrypted license for the excerpt of the content item, the license comprising at least one indicator of the units covered by the license; decrypt the encrypted license; retrieve stored information regarding licenses previously delivered to the first device; compare a limit value for the content item with the stored information combined with information from the license; and send the license to the device only if the limit value is not exceeded by the stored information combined with information from the license.

In a first preferred embodiment, the processor is further configured to: receive an encryption key from the device; and encrypt the decrypted license using the encryption key before sending it to the device.

In a third aspect, the invention is directed to an apparatus for controlling distribution of licenses, a license being for an excerpt of a content item, the content item comprising a set of units, each excerpt comprising a subset of the set of units, the apparatus comprising a processor configured to: receive, from a first device, a request for an authorization to send a license for the excerpt of the content item to a second device, the request comprising at least one indicator of the units covered by the license; retrieve stored information regarding licenses previously delivered to the second device; compare a limit value for the content item with the stored information combined with information from the request; and send the authorization to the first device only if the limit value is not exceeded by the stored information combined with information from the license.

In a fourth aspect, the invention is directed to an apparatus for controlling distribution of licenses, a license being for an excerpt of a content item, the content item comprising a set of units, each excerpt comprising a subset of the set of units, the apparatus comprising a processor configured to: receive a request for a license for the excerpt of the content item, the request comprising an identifier of a receiver of the license and at least one indicator of the units to be covered by the license; retrieve stored information regarding licenses previously delivered to the receiver; compare a limit value for the content item with the stored information combined with information from the request; and, only if the limit value is not exceeded by the stored information combined with information from the license: generate the license for the excerpt, the license comprising control words for the subset, and send the license to the receiver.

In a first preferred embodiment, the request is received from a first device having a license for the content item the first device being separate from the receiver.

In a second preferred embodiment, the request is received from the receiver, the receiver having received the excerpt from a second device.

In a third preferred embodiment, the processor is configured to obtain the control words for the subset from a master control word for the content item.

In a fourth preferred embodiment, the processor is configured to obtain the control words from a stored database.

In a fifth aspect, the invention is directed to a method for controlling distribution of licenses, a license being for an excerpt of a content item, the content item comprising a set of units, each excerpt comprising a subset of the set of units. An apparatus receives a license for the excerpt of the content item, the license comprising at least one indicator of the units covered by the license; retrieves stored information regarding licenses previously delivered to the apparatus; compares a limit value for the content item with the stored information combined with information from the license; and uses the license to access the excerpt only if the limit value is not exceeded by the stored information combined with information from the license.

In a sixth aspect, the invention is directed to a method for controlling distribution of licenses, a license being for an excerpt of a content item, the content item comprising a set of units, each excerpt comprising a subset of the set of units. An apparatus receives, from a device, an encrypted license for the excerpt of the content item, the license comprising at least one indicator of the units covered by the license; decrypts the encrypted license; retrieves stored information regarding licenses previously delivered to the first device; compares a limit value for the content item with the stored information combined with information from the license; and sends the license to the device only if the limit value is not exceeded by the stored information combined with information from the license.

In a seventh aspect, the invention is directed to a method for controlling distribution of licenses, a license being for an excerpt of a content item, the content item comprising a set of units, each excerpt comprising a subset of the set of units. An apparatus receives, from a first device, a request for an authorization to send a license for the excerpt of the content item to a second device, the request comprising at least one indicator of the units covered by the license; retrieves stored information regarding licenses previously delivered to the second device; compares a limit value for the content item with the stored information combined with information from the request; and sends the authorization to the first device only if the limit value is not exceeded by the stored information combined with information from the license.

In an eighth aspect, the invention is directed to a method for controlling distribution of licenses, a license being for an excerpt of a content item, the content item comprising a set of units, each excerpt comprising a subset of the set of units. An apparatus receives a request for a license for the excerpt of the content item, the request comprising an identifier of a receiver of the license and at least one indicator of the units to be covered by the license; retrieves stored information regarding licenses previously delivered to the receiver; compares a limit value for the content item with the stored information combined with information from the request; and, only if the limit value is not exceeded by the stored information combined with information from the license: generates the license for the excerpt, the license comprising control words for the subset and sends the license to the receiver.

### BRIEF DESCRIPTION OF DRAWINGS

Preferred features of the present invention will now be described, by way of non-limiting example, with reference to the accompanying drawings, in which

FIG. 1 illustrates content divided into a plurality of units;

FIG. 2 illustrates a system according to a preferred embodiment of a decentralised approach of the present invention; and

FIG. 3 illustrates a system according to a preferred embodiment of a centralised approach of the present invention.

### DESCRIPTION OF EMBODIMENTS

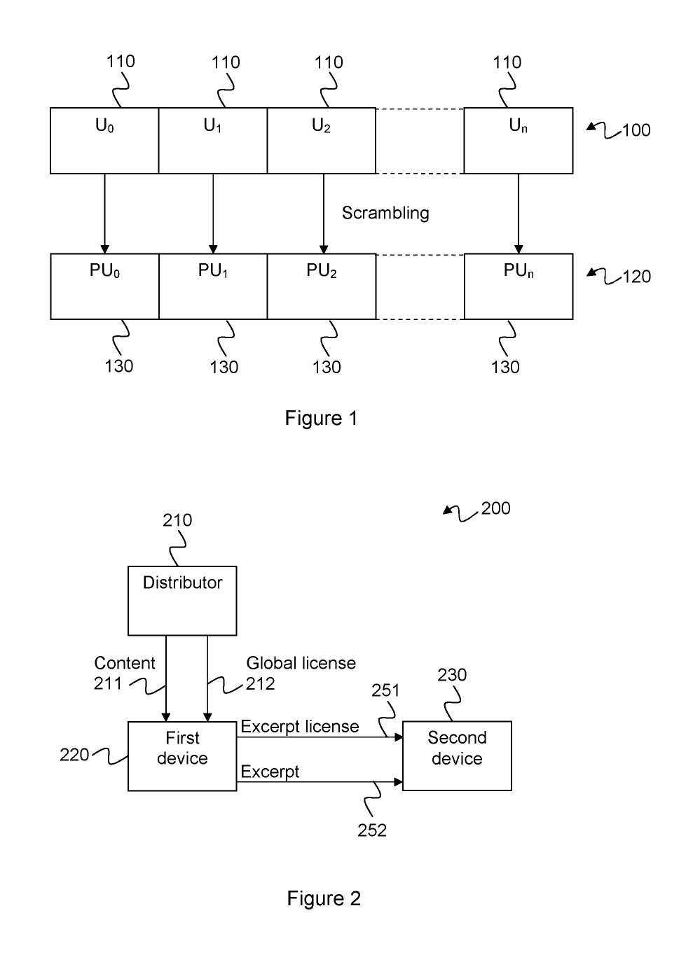

A co-pending application teaches a DRM solution, illustrated in FIG. 1, in which an item of content 100 is partitioned into a set of sequential sequences called ‘units’ 110, each unit being identified by a unit index (j). The content 100 thus comprises the set of units {U₀, U₁, U₂, . . . , Uₙ}. For delivery to an end user, the units are scrambled separately, a distinct control word (CW) being used for each unit. The resulting protected units 130 form a protected content 120. The CWs are generated from a master CW that is comprised in a (global) content license that also is delivered to the end user.

The (first) end user may select a number of units to be sent to a second end user, generate the distinct CWs for the selected units and send the selected, protected units and an excerpt license comprising the generated, distinct CWs to the second end user. The use of a suitable CW generation algorithm ensures that the second user cannot generate CWs for other parts of the content than the parts of the excerpt. The selected number of units 110 make up a subset (or portion) of the content item 100; the subset is not necessarily contiguous, i.e. an excerpt license may be generated for units belonging to two or more separate parts such as for example U₀-U₃₀₀ and U₅₀₀-U₇₀₀. This can enable generation of an excerpt license for the goals of a football match or the like.

However, it is conceivable that the first end user, or several end users, sends a plurality of excerpts to the second end user, thereby enabling the second end user to access the entire content item (or a major part thereof). The present invention seeks to overcome this problem.

An object of the present invention is thus to ensure that there is a limit to the amount of a content item that a device can access (i.e. render) through excerpt licenses. There are at least two possible solutions: a decentralised approach and a centralised approach.

Decentralised Approach

FIG. 2 illustrates a system according to a preferred embodiment of the decentralised approach of the present invention. The system 200 comprises a distributor 210, a first device 220, and a second device 230.

The distributor 210 is configured to protect and distribute a content item 211 and the corresponding global content license 212 to a first device 220, as described hereinbefore with reference to FIG. 1.

The first device 220 is configured to select, following instructions from the first end user, an excerpt of the content 252 and to send the excerpt with a corresponding excerpt license 251 to the second device 230.

The second device 230 is configured to receive, from the first end user device, the excerpt of the content 252 and the corresponding excerpt license 251. If authorized to do so, the second device 230 is able to render the content of the excerpt 252.

When the first device 220 has received instructions to send an excerpt 252 to the second device 230, it generates the excerpt license 251, as previously described herein, and sends the excerpt license 251 to the second device 230. It is advantageous that the excerpt 252 is sent as well, but it should be appreciated that the excerpt 252 may also be received (possibly as part of a bigger excerpt or indeed the entire content item) by the second device 230 from a different source (or sources) provided that the excerpt license comprises sufficient information to allow the second device 230 to identify the units for which the excerpt license 251 comprises control words.

The excerpt license 251 preferably comprises an identifier of the content item, a list of pairs {unit index; CW}, and an integrity checksum. The first device 220 preferably encrypts the excerpt license 251 with a public key of the second device 230.

Upon reception of the excerpt license 251, the second device 230 decrypts it using its private key, if necessary, and checks the integrity of the excerpt license 251 using the integrity checksum. If the integrity is verified, then the second device 230 verifies if accessing the excerpt would bring it above the authorized limit for the content item. The limit may for example be expressed as a number of units and/or as a number of excerpts. To verify this, the second device 230 retrieves a stored counter (of e.g. the number of accessed units and/or excerpts) for the content identifier, adjusts the counter value with the relevant number from the received excerpt license (e.g. the number of units) and checks if the adjusted counter value exceeds a threshold value. If this is the case, then the second device 230 is not authorized to access the excerpt and advantageously erases the excerpt license (and possibly the excerpt). However, if the threshold is not exceeded, then the second device 230 updates the counter value and uses the excerpt license 252 to access the content of the excerpt 252.

The second device 230 comprises at least one processor (not shown) configured to perform the necessary calculations and memory (also not shown) for storing a database with content identifiers and corresponding counter values. In a variant embodiment, the memory stores the index values of the units that it has already accessed, which allows the second device 230 to receive the same unit twice while it is only counted as one unit for purposes of the counter value.

Centralised Approach

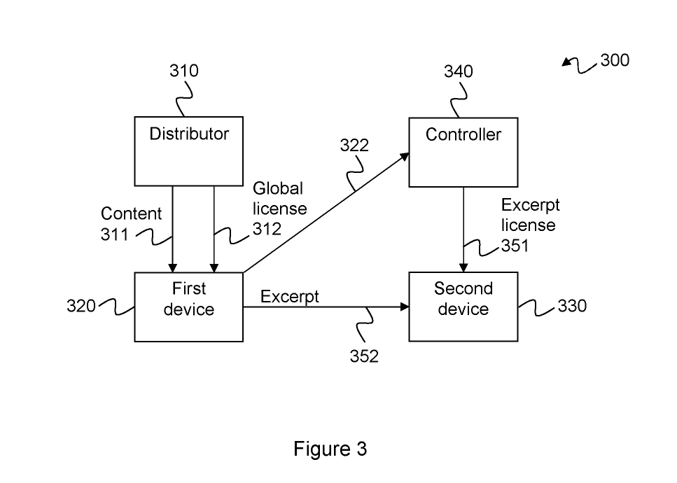

FIG. 3 illustrates a system according to a preferred embodiment of the centralised approach of the present invention. The system 300 comprises a distributor 310, a first device 320, a second device 330, and a central excerpt controller 340.

The distributor 310 is configured to protect and distribute a content item 311 and the corresponding global content license 312 to a first end user, as described hereinbefore with reference to FIGS. 1 and 2. The distributor 310 can also provide the central excerpt controller 340 with information, such as the master CW, that enables generation of an excerpt license.

The first device 320 is configured to select an excerpt 352 of the content that is to be sent with a corresponding excerpt license to the second end user. As in the decentralized approach, the excerpt 352 may be obtained by the second device 330 from other sources than the first device 320, provided that the excerpt license comprises enough information to identify the units for which the excerpt license comprises control words.

However, in the centralized approach, the excerpt license may be delivered to the second device 330 in a number of different ways.

In a first variant, illustrated in FIG. 3, the first device 320 sends a license request 322 to the central excerpt controller 340. The license request 322 comprises the identity of the second device 330 (preferably in a certificate that further comprises the public key of the second device 330), a content identifier, a list of unit indices to be included in the excerpt license, and an integrity checksum. The license request 322 may, but is not necessarily protected by, for example, encryption.

The central excerpt controller 340, which stores a record database for each managed device, verifies that the units of the excerpt will not bring the number of units (and/or excerpts) received by the second device 330 above a maximum authorized number of units (or excerpts) for the second device 330. The database preferably comprises, for each device therein, a list of content identifiers and, for each content identifier, the units that have been delivered to the receiving device.

If the maximum number is reached, then the license request is refused; otherwise, the central excerpt controller 340 generates an excerpt license 351 and delivers this to the second device 330. The excerpt license 351 preferably comprises the content identifier, a list of {index; CW} pairs, and an integrity checksum. The excerpt license is preferably encrypted using the public key of the second device 330. The central excerpt controller 340 also updates its database with the information in the generated excerpt license 351.

In a second variant, it is the second device 330 that sends the license request to the central excerpt controller 340.

In the first and second variants, the central excerpt controller 340 may obtain the control words in at least one of the following ways. First, the central excerpt controller 340 may implement the CW generation algorithm and use the master CW to generate the unit CWs. Second, the central excerpt controller 340 may receive and store a complete list of unit CWs from the distributor 310.

In a third variant, the first device 320 sends a license request 322 to the central excerpt controller 340 that verifies whether the second device 330 is authorized to receive the excerpt license, as in the first variant. If the second device 330 is authorized, then the central excerpt controller 340 returns an authorization to the first device 320 that then may generate the excerpt license and send it to the second device 330.

In a fourth variant, the first device 320 encrypts the excerpt license with the public key of the central excerpt controller 340. Upon reception of the excerpt license, the second device 330 sends the excerpt license to the central excerpt controller 340, possibly together with its own public key. The central excerpt controller 340 decrypts the excerpt license and verifies if the second device 330 is authorized to access the excerpt. If this is the case, then the central excerpt controller 340 encrypts the excerpt license with the public key of the second device 330 and returns the re-encrypted excerpt license.

Upon reception of the excerpt license 351, the second device 330 preferably decrypts it, using its private key, checks the validity of the integrity checksum. If the checksum is correct, then the CWs in the excerpt license 351 may be used to descramble and then render the excerpt.

The invention also relates to a computer program product, such as a DVD or a CD-ROM, that stores instructions, which, when executed by a processor, causes the processor to perform the method of the present invention.

It will be appreciated that the present invention can enable sharing of portions of a protected content, without making the entire content available to the recipient.

Each feature disclosed in the description and (where appropriate) the claims and drawings may be provided independently or in any appropriate combination. Reference numerals appearing in the claims are by way of illustration only and shall have no limiting effect on the scope of the claims.

1. An apparatus for controlling distribution of licenses, a license being for an excerpt of a content item, the content item comprising a set of units, each excerpt comprising a subset of the set of units, the apparatus comprising a processor configured to
receive a license for the excerpt of the content item, the license comprising at least one indicator of the units covered by the license;
retrieve stored information regarding licenses previously delivered to the apparatus;
compare a limit value for the content item with the stored information combined with information from the license; and
use the license to access the excerpt only if the limit value is not exceeded by the stored information combined with information from the license.

2. The apparatus of claim 1, wherein the processor is further configured to receive the excerpt of the content item.

3. An apparatus for controlling distribution of licenses, a license being for an excerpt of a content item, the content item comprising a set of units, each excerpt comprising a subset of the set of units, the apparatus comprising a processor configured to:
receive, from a device, an encrypted license for the excerpt of the content item, the license comprising at least one indicator of the units covered by the license;
decrypt the encrypted license;
retrieve stored information regarding licenses previously delivered to the first device;
compare a limit value for the content item with the stored information combined with information from the license; and
send the license to the device only if the limit value is not exceeded by the stored information combined with information from the license.

4. The apparatus of claim 3, wherein the processor is further configured to:
receive an encryption key from the device; and
encrypt the decrypted license using the encryption key before sending it to the device.

5. An apparatus for controlling distribution of licenses, a license being for an excerpt of a content item, the content item comprising a set of units, each excerpt comprising a subset of the set of units, the apparatus comprising a processor configured to:
receive, from a first device, a request for an authorization to send a license for the excerpt of the content item to a second device, the request comprising at least one indicator of the units covered by the license;
retrieve stored information regarding licenses previously delivered to the second device;
compare a limit value for the content item with the stored information combined with information from the request; and
send the authorization to the first device only if the limit value is not exceeded by the stored information combined with information from the license.

6. An apparatus for controlling distribution of licenses, a license being for an excerpt of a content item, the content item comprising a set of units, each excerpt comprising a subset of the set of units, the apparatus comprising a processor configured to:
receive a request for a license for the excerpt of the content item, the request comprising an identifier of a receiver of the license and at least one indicator of the units to be covered by the license;
retrieve stored information regarding licenses previously delivered to the receiver;
compare a limit value for the content item with the stored information combined with information from the request; and
only if the omit value is not exceeded by the stored information combined with information from the license:
generate the license for the excerpt, the license comprising control words for the subset; and
send the license to the receiver.

7. The apparatus of claim 6, wherein the request is received from a first device having a license for the content item the first device being separate from the receiver.

8. The apparatus of claim 6, wherein the request is received from the receiver, the receiver having received the excerpt from a second device.

9. The apparatus of claim 6, wherein the processor is configured to obtain the control words for the subset from a master control word for the content item.

10. The apparatus of claim 6, wherein the processor is configured to obtain the control words from a stored database,

11. A method for controlling distribution of licenses, a license being for an excerpt of a content item, the content item comprising a set of units, each excerpt comprising a subset of the set of units, the method comprising the steps, at an apparatus, of:
receiving a license for the excerpt of the content item, the license comprising at least one indicator of the units covered by the license;
retrieving stored information regarding licenses previously delivered to the apparatus;
comparing a limit value for the content item with the stored information combined with information from the license; and
using the license to access the excerpt only if the limit value is not exceeded by the stored information combined with information from the license.

12. A method for controlling distribution of licenses, a license being for an excerpt of a content item, the content item comprising a set of units, each excerpt comprising a subset of the set of units, the method comprising the steps, at an apparatus, of:
receiving, from a device, an encrypted license for the excerpt of the content item, the license comprising at least one indicator of the units covered by the license;
decrypting the encrypted license;
retrieving stored information regarding licenses previously delivered to the first device;
comparing a limit value for the content item with the stored information combined with information from the license; and
sending the license to the device only if the omit value is not exceeded by the stored information combined with information from the license.

13. A method for controlling distribution of licenses, a license being for an excerpt of a content item, the content item comprising a set of units, each excerpt comprising a subset of the set of units, the method comprising the steps, at an apparatus, of:
receiving, from a first device, a request for an authorization to send a license for the excerpt of the content item to a second device, the request comprising at least one indicator of the units covered by the license;
retrieving stored information regarding licenses previously delivered to the second device;
comparing a limit value for the content item with the stored information combined with information from the request; and
sending the authorization to the first device only if the limit value is not exceeded by the stored information combined with information from the license°

14. A method for controlling distribution of licenses, a license being for an excerpt of a content item, the content item comprising a set of units, each excerpt comprising a subset of the set of units, the method comprising the steps, at an apparatus, of:
receiving a request for a license for the excerpt of the content item, the request comprising an identifier of a receiver of the license and at least one indicator of the units to be covered by the license;
retrieving stored information regarding licenses previously delivered to the receiver;
comparing a limit value for the content item with the stored information combined with information from the request; and
only if the limit value is not exceeded by the stored information combined with information from the license:
generating the license for the excerpt, the license comprising control words for the subset; and
sending the license to the receiver.
